(19) United States
(12) Patent Application Publication
(10) Pub. No.: US 2016/0334262 A1
(43) Pub. Date: Nov. 17, 2016

(54) TENSIONED COAXIAL PROBE FOR LEVEL MEASUREMENT

(71) Applicant: Honeywell International Inc., Morris Plains, NJ (US)

(72) Inventors: FRANK MARTIN HARAN, N. VANCOUVER (CA); STUART JAMES HEATH, SURREY (CA)

(21) Appl. No.: 14/883,180

(22) Filed: Oct. 14, 2015

Related U.S. Application Data
(60) Provisional application No. 62/159,706, filed on May 11, 2015.

(51) Int. Cl. G01F 23/284; G01S 7/02

(52) U.S. Cl. CPC G01F 23/284; G01S 7/02

(57) ABSTRACT

A coaxial probe for a time-domain reflectometry (TDR) fill-level measuring system includes an outer electrically conductive tube (outer tube), an inner electrically conductive rod (inner rod) within the outer tube on at least one end, and at least one tensioning device (tensioning device). The tensioning device includes a tensioner body between the inner rod and outer tube for stretching the inner rod in a length direction relative to the outer tube to tension the inner rod. The tensioning device is placed at at least one of an end of a lower probe portion and an end of an upper probe portion of the coaxial probe.

### CROSS REFERENCE TO RELATED APPLICATIONS

This application claims the benefit of Provisional Application Ser. No. 62/159,706 entitled “TENSIONED COAXIAL PROBE FOR LEVEL MEASUREMENT”, filed on May 11, 2015, which is herein incorporated by reference in its entirety.

### FIELD

Disclosed embodiments relate to coaxial probes for time-domain reflectometry-based guided wave level measurement.

### BACKGROUND

Time-domain reflectometry (TDR) can be used as a level determination method involving analyzing reflection characteristics of electromagnetic waves and signals. There are many different types of TDR-based level measuring systems including contact radar such as guided wave radar (GWR), non-contact radar, ultrasonics, and laser. In a GWR TDR-based level measuring system, a microwave pulse is generated by level gauge electronics including a transceiver and processor which is coupled by a process connection into a waveguide (or probe) that is guided along the length of the probe that extends into the tank. The probe can be a coaxial waveguide, a metal rod or a steel cable. If the microwave pulse is incident on the surface of the medium to be measured, part of the pulse is reflected at the surface and returns along the probe to the gauge electronics, which then calculates the fill level from the time difference between the transmitted pulse and the received pulse.

The gauge can output the calculated fill level as a continuous analog signal (typically 4-20 mA) or as a digital signal. An advantage of this method is that the measurement result is only to a small extent influenced by the properties of the medium to be measured, for example density, conductivity and dielectric constant, or by the environmental conditions such as pressure and temperature, and that no interference-prone moving parts are required.

In GWR level measurement systems a coaxial probe (or coaxial waveguide) is commonly used when interfering obstacles or process conditions can adversely degrade the accuracy of the level measurements rather than a lower cost single wire or single rod probe design. Such coaxial probes typically comprise an inner rod in an outer tube design with spacers between the inner rod and outer tube that are placed periodically along the length of the coaxial probe. The spacers are used to ensure that the distance between the inner rod and outer tube is maintained within a certain tolerance so that the measurement is not degraded by deflection of the inner rod in vibrational or non-vertically mounted installations.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize the presence of conventional spacer(s) in coaxial probes (or waveguides) for level measurement by level gauges positioned between the inner electrically conductive rod (inner rod) and outer electrically conductive tube (outer tube) for ensuring the distance between the inner rod and outer tube is maintained within a certain tolerance for guided wave radar (GWR) level measurement systems can result in degraded measurement accuracy. By tensioning the inner rod, it has been found that the stiffness of the inner rod increases, which reduces the deformation or deflection of the inner rod under forces such as vibration, gravity, environmental influences such as temperature, or deformation or deflection over time (creep). Tensioning the inner rod enables a reduction in the number of spacers or in some cases (e.g., for probe lengths ≦2 m) removing the need for spacers altogether, while still maintaining a given spacing tolerance between the inner rod and outer tube.

Tension can be applied to the inner rod through a wide variety of different structures and methods. For example, using threads internal/external on the inner rod, or internal/external on the outer tube. The springs can be coil type or leaf type, and be retained either on the inner rod or on the outer tube.

For example, to tension the inner rod a tensioning device including a tensioner body can be positioned between the inner rod and the outer tube. The tensioner body has an aperture through which a threaded member is inserted through for screwing the threaded member into the inner threading of the inner rod which functions to stretch the inner rod in a length (height) direction relative to the outer tube, which can be provided at one or both ends of the coaxial probe. The tensioning device may also include a flexible member between the head of the screw and the tensioner body, such as a spring or a Bellville washer, designed to take up changes in coaxial probe's dimensions due to temperature or creep over time. The tensioning device can provide a tension load to the inner rod of 10 N to 10,000 N, such as about 100 N to 500 N in one embodiment.

### BRIEF DESCRIPTION OF THE DRAWINGS

FIG. 1A shows components of a level gauging system generally used for a time-domain reflectometry (TDR) fill-level measuring instrument including an electronic level gauge (ELG) coupled to an example coaxial probe having an upper probe portion, an intermediate probe portion, and a lower probe portion that as shown in FIG. 1B includes an example tensioning device on its bottom end between the inner rod and outer tube, according to an example embodiment.

FIGS. 1C-E shows several depictions with example details of an upper probe portion joined to an intermediate probe portion, tensioner body and spacer, respectively, according to example embodiments.

FIG. 1F shows a close-up view of an example tensioning device installed on the bottom of a lower probe portion having a flexible member shown as a washer between the socket head of a socket head cap screw and tensioner body for taking up changes in a dimension of the coaxial probe due to temperature or creep over time, according to an example embodiment.

FIG. 1G shows a close-up view of an example tensioning device installed on the bottom of a lower probe portion showing a socket head cap screw within the inner aperture of the tensioning body having threads on the screw end for screwing into inner threading of the inner rod which stretches the inner rod in a length direction relative to the outer tube to tension the inner rod, according to an example embodiment.

FIG. 1H is an exploded view of the components shown in FIG. 1G.

FIGS. 2A-D show several example tensioning device arrangements, according to example embodiments.

FIG. 3 is a block diagram of an example ELG system mounted to a tank having a disclosed coaxial probe for measuring the level of a material in the tank using GWR, according to an example embodiment.

FIG. 4 shows calculated deflection data for a metal rod under tension illustrating the magnitude of deflection of an inner rod of a coaxial probe for several inner rod lengths showing un-tensioned control inner rods and disclosed tensioned inner rods according to an example embodiment.

### DETAILED DESCRIPTION

Disclosed embodiments are described with reference to the attached figures, wherein like reference numerals, are used throughout the figures to designate similar or equivalent elements. The figures are not drawn to scale and they are provided merely to illustrate aspects disclosed herein. Several disclosed aspects are described below with reference to example applications for illustration. It should be understood that numerous specific details, relationships, and methods are set forth to provide a full understanding of the embodiments disclosed herein.

One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. Disclosed embodiments are not limited by the illustrated ordering of acts or events, as some acts may occur in different orders and/or concurrently with other acts or events. Furthermore, not all illustrated acts or events are required to implement a methodology in accordance with this Disclosure.

Also, the terms “coupled to” or “couples with” (and the like) as used herein without further qualification are intended to describe either an indirect or direct electrical connection. Thus, if a first device “couples” to a second device, that connection can be through a direct electrical connection where there are only parasitics in the pathway, or through an indirect electrical connection via intervening items including other devices and connections. For indirect coupling, the intervening item generally does not modify the information of a signal but may adjust its current level, voltage level, and/or power level.

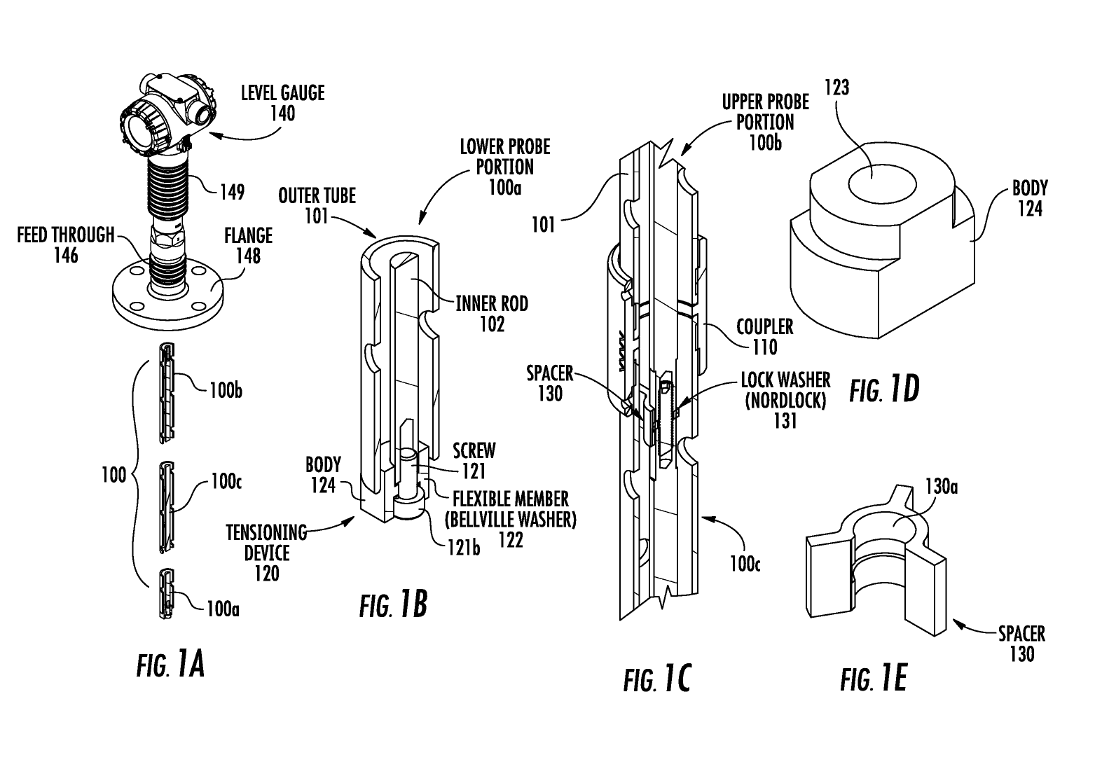

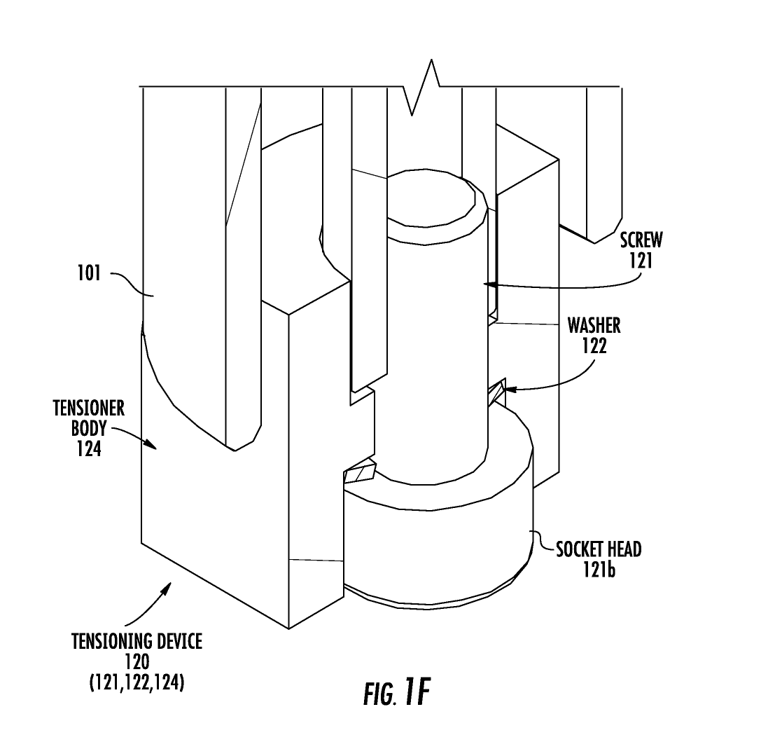

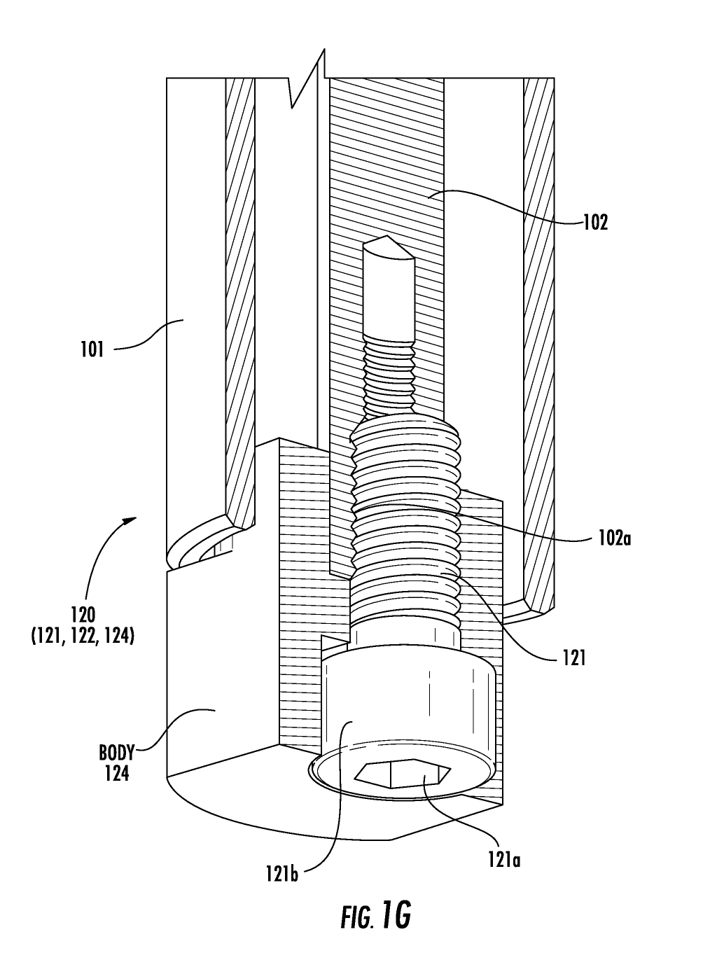

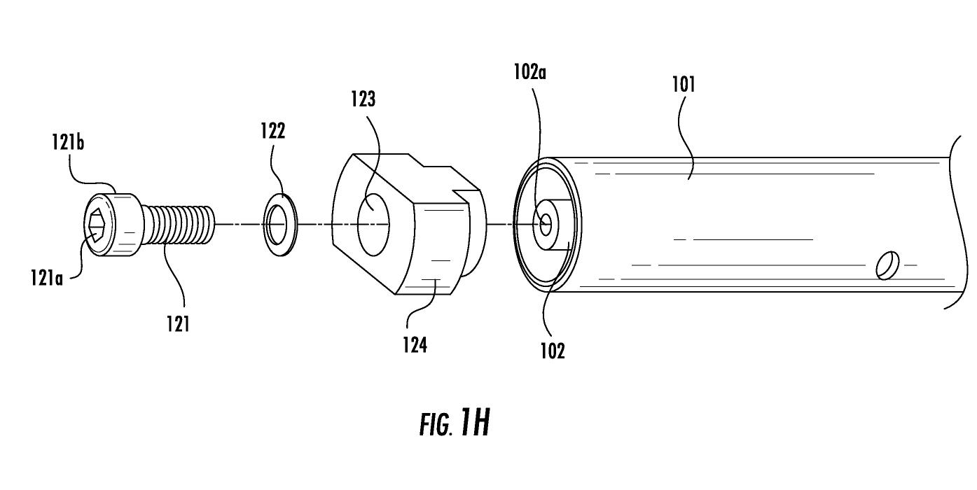

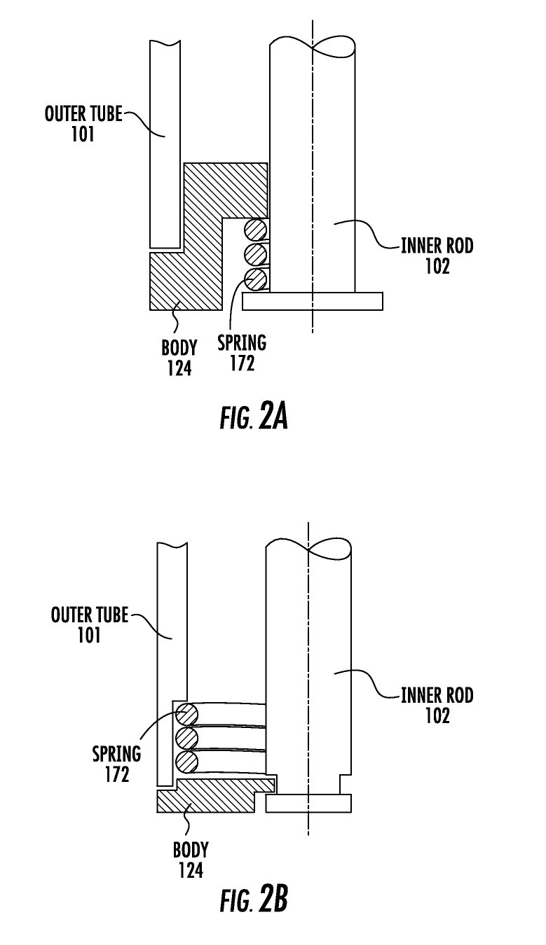

FIG. 1A shows components of a GWR level gauging system generally used for a time-domain reflectometry (TDR) fill-level measuring instrument including an electronic level gauge (ELG) 140 shown as a “level gauge” coupled to an example coaxial probe 100, according to an example embodiment. The coaxial probe 100 is shown in an exploded view with representations for an upper probe portion 100b, an intermediate probe portion 100c and a lower probe portion 100a that as shown in FIG. 1B includes a tensioning device 120 on its bottom. Although the coaxial probe 100 is shown having 3 segments with an upper segment corresponding to upper probe portion 100b, intermediate segment corresponding to intermediate probe portion 100c, and lower segment corresponding to lower probe portion 100a, alternatively the coaxial probe 100 can include any other number of sections including a single continuous (integral) non-sectionalized probe, two sections, or 4 or more sections by including a plurality of intermediate sections.

Tension as known in physics is the act of stretching or straining, where a tensioning force produces an elongation of a body or structure such as a rod. Tension is the force that can be exerted by a rope, string, cable, or similar object on one or more objects, such as rods in the case of disclosed embodiments.

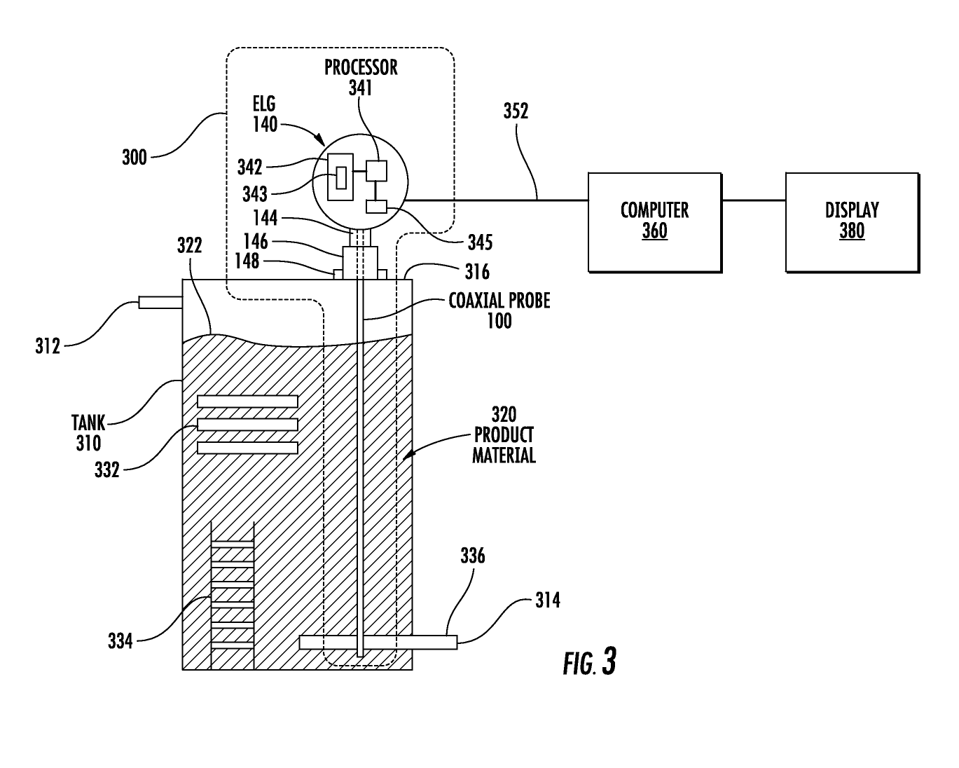

The ELG 140 is shown adapted to be mounted onto the top of a tank through an electronics housing 149, feed-through (or process connection) 146, and a flange 148 that couples the ELG 140 to the coaxial probe 100 which is inserted over a tank aperture (not shown) generally in the top of the tank (see tank 310 in FIG. 3 described below). As shown in FIG. 1B, the coaxial probe 100 includes an outer tube 101, an inner rod 102 within the outer tube 101 and at least one tensioning device for tensioning the inner rod placed between the inner rod 102 and the outer tube 101 at one or both of a top end and a bottom end of the coaxial probe 100.

FIG. 1B shows details for an example lower probe portion 100a including tensioning device 120 comprising a tensioner body 124 having an inner aperture 123 (see inner aperture 123 shown in FIG. 1D) sized to fit within the outer tube 101. The lower probe portion 100a is shown comprising a screw shown as a socket head cap screw (screw) 121 having a socket head 121b within the inner aperture, and an optional flexible member, such as a spring or Bellville washer 122. The threaded end of the screw 121 is configured to screw into inner threading of the inner rod 102 for stretching the inner rod 102 in a length direction relative to the outer tube 101. The flexible member 122 is between the socket head of the screw 121 and the tensioner body 124 for taking up changes in the length of the coaxial probe 100 due to temperature or creep over time. A Belleville washer, also known as a coned-disc spring, conical spring washer, disc spring, Belleville spring or cupped spring washer, is a type of spring shaped like a washer. It has a frusto-conical shape which gives the washer a spring characteristic.

FIG. 1C shows details for an example upper probe portion 100b joined to an intermediate probe portion 100c by an outer tube coupler (coupler) 110, including a spacer 130 proximate to the joint having a center aperture 130a shown in FIG. 1E that the inner rod 102 is inserted in, and at least one lock washer 131 which holds the spacer 130 in place. Spacer 130 generally comprises a dielectric material such as polytetrafluoroethylene (PTFE), but can comprise other dielectric materials such as polyetheretherketone (PEEK, a mechanically robust thermoplastic polymer) or a ceramic material.

FIG. 1D shows a tensioner body 124 having an inner aperture 123. Tensioner body 124 can comprise a metal, a polymer such as PTFE for some less challenging applications, or a mechanically robust polymer such as PEEK which is also machinable and well suited for temperature applications between about −40° C. to 200° C., or a ceramic material for more difficult applications such as for temperatures ranging from −200° C. to 450° C. The material for tensioner body 124 may be ground or otherwise machined to obtain a desired shape.

FIG. 1F shows a close-up view of an example tensioning device 120 configured as an essentially rigid block installed within the outer tube 101 on the bottom of a lower probe portion. Tensioning device 120 comprises a flexible member 122 shown as a washer between the socket head 121b of a socket head cap screw 121 and the tensioner body 124 for taking up changes in a dimensions of the coaxial probe due to temperature or creep over time.

FIG. 1G shows a three dimensional (3D) close-up view of an example tensioning device 120 installed on the bottom of a lower probe portion. Tensioning device 120 shows a screw 121 within the inner aperture of the tensioning body 124 having threads on the screw end for screwing into inner threading 102a of the inner rod 102 which stretches the inner rod 102 in a length direction relative to the outer tube 101 to tension the inner rod 102. The socket head 121b of the screw 121 is shown having a cutout 121a for receiving an Allen key that can be used to adjust the tension level applied to the inner rod 102, with tightening generally increasing the level of applied tension. FIG. 1H is an exploded view of the components shown in FIG. 1G with a flexible member 122 shown as a washer added.

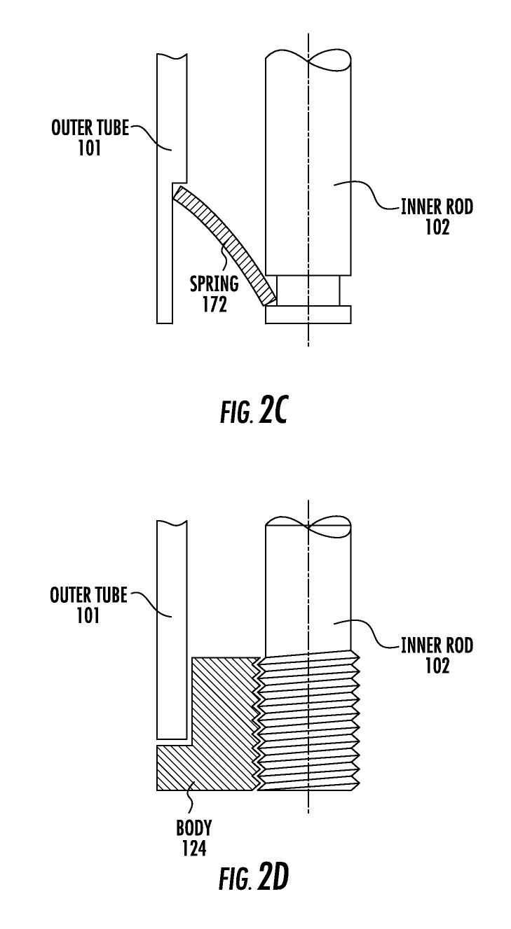

FIGS. 2A-D show several example alternate tensioning device arrangements. A spring 172 is shown in FIGS. 2A-2C. The tensioning device in FIG. 2C comprises only a spring 172, which can comprise a metal or a polymer. In FIG. 2D the tensioner body 124 is shown having an edge feature pattern that matches the feature pattern for locking together on the end of the inner rod 102.

FIG. 3 is a block diagram of an example ELG system 300 including an ELG 140 mounted onto the top 316 of a tank 310 having a disclosed coaxial probe 100 for measuring the level of a material in the tank using GWR, according to an example embodiment. System 300 can be used in a variety of manufacturing plants that handle and process a tangible material. The tank 310 contains a liquid or other product material 320 (liquid or bulk solid (e.g., powder)). The tank 310 has an inlet 312 and an outlet 314. The liquid or other product material 320 fills the tank 310 to an upper level or surface 322. Several obstacles or obstructions are shown located within tank 310 including heater coils 332, ladder 334 and outlet pipe 336. As known in the art, the presence of the heater coils 332, ladder 334 and outlet pipe 336 in the tank 310 may make necessary the use of a coaxial probe for measurement accuracy.

The ELG 140 generally includes a transceiver (which as used herein can include a separate transmitter and receiver), a computing device such as a processor 341 (e.g., digital signal processor (DSP), microprocessor or microcontroller unit (MCU)) having an associated memory 342 that stores a radar level determination algorithm (radar level algorithm) 343 as firmware. Other electronics, such as signal amplifiers, filters, an analog-to-digital converter (ADC, in the receive circuitry) and digital-to-analog converter (DAC, in the transmit circuitry) are generally part of ELG 140, but are not shown to provide simplicity.

ELG 140 provides continuous level (volume) measurement for the liquid or other product material 320 of high reliability at a generally reasonable price. The reliability is obtained due to lack of moving parts and insensitivity of the measurements to changes in process pressure, temperature, and density of measured material. The radar level algorithm 343 measures the distance from a reference point, usually a fixed internal reflection at the top of the antenna (or waveguide) to the surface of the product material in the tank using reflection of the measuring signal from the level or surface 322 of the liquid or other product material 320 in the tank 310.

ELG 140 as shown is mounted to the top 316 of the tank 310 by a process connection comprising a coaxial connector 144, feed-through 146, and flange 148 that couple the transceiver 345 of the ELG 140 to the coaxial probe 100 which is inserted over a tank aperture (not shown) in the top 316 of the tank 310. As shown, coaxial probe 100 extends well into the liquid or other product material 320 in the tank 310 to create physical contact, such as to implement GWR.

ELG 140 is shown coupled to a remote computer 360 having a local display 380 (such as being a control room of a plant) via a cable (e.g., electrical cable) 352. Coupling between ELG 140 and computer 360 may also be accomplished wirelessly. For GWR applications, coaxial probe 100 extends to essentially the bottom of the tank 310 or to a portion of the tank (if only a portion of the tank needs to be measured). The measurement signal propagates along coaxial probe 100 to the product material 320 and is then reflected back to ELG 140.

ELG 140 can transmit electrical signals representative of the distance from the top 316 of tank 310 to the level 322 of liquid or other product material 320 in the tank 310 to the processor 341. Processor 341 can perform any one or more of the methods, processes, operations, applications, or methodologies described herein. For example, processor 341 can implement the radar level algorithm 343 from digitized versions of received electrical signals resulting from the reflected electromagnetic signals (echo signals) received by the transceiver 345 representative of the measured distance from the top of tank to the level of liquid or other material, and using a stored total height of the tank 310 can calculate the material level by subtracting the measured distance from the total height of the tank 310.

### EXAMPLES

Disclosed embodiments of the invention are further illustrated by the following specific Examples, which should not be construed as limiting the scope or content of this Disclosure in any way.

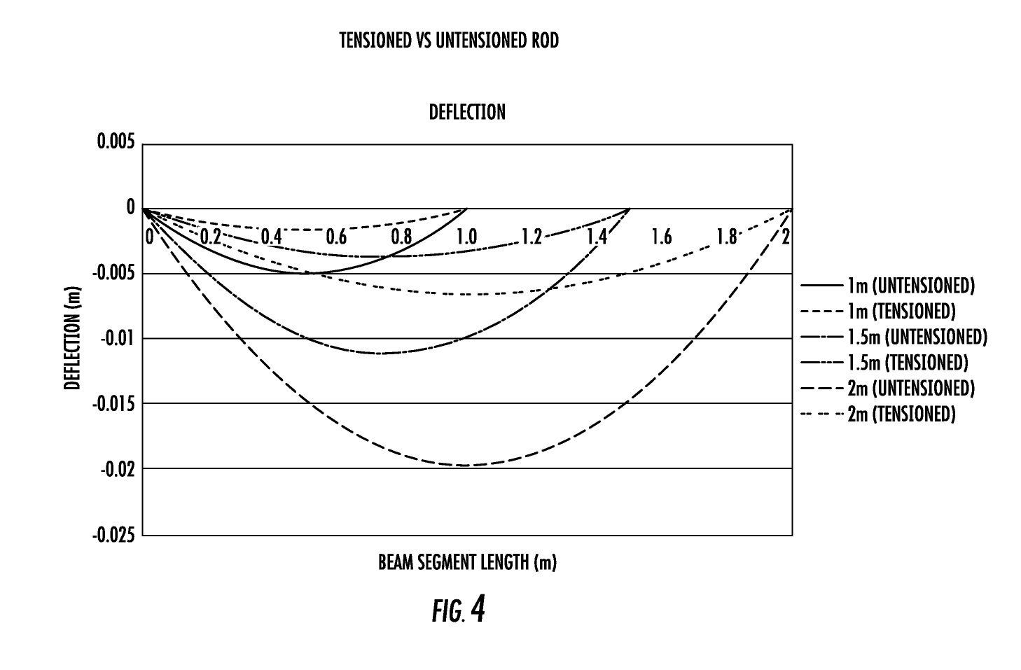

FIG. 4 shows calculated deflection data obtained from a catenary equation for metal rods under tension illustrating the deflection (in meters (m)) of an inner rod of a coaxial probe section for several section lengths (1 m, 1.5 m and 2 m) showing un-tensioned controls and disclosed tensioned inner rods, according to an example embodiment. The deflection condition used was a 1 G lateral load. Disclosed tensioned inner rods can be seen to approximately half the deflection of the un-tensioned control inner rods.

While various disclosed embodiments have been described above, it should be understood that they have been presented by way of example only, and not as a limitation. For example, besides tension as disclosed above, applying compression to the inner rod may also reduce its deflection. Numerous changes to the disclosed embodiments can be made in accordance with the Disclosure herein without departing from the spirit or scope of this Disclosure. Thus, the breadth and scope of this Disclosure should not be limited by any of the above-described embodiments. Rather, the scope of this Disclosure should be defined in accordance with the following claims and their equivalents.

Although disclosed embodiments have been illustrated and described with respect to one or more implementations, equivalent alterations and modifications will occur to others skilled in the art upon the reading and understanding of this specification and the annexed drawings. While a particular feature may have been disclosed with respect to only one of several implementations, such a feature may be combined with one or more other features of the other implementations as may be desired and advantageous for any given or particular application.

1. A coaxial probe for a time-domain reflectometry (TDR) fill-level measuring system, comprising:
an outer electrically conductive tube (outer tube);
an inner electrically conductive rod (inner rod) within said outer tube on at least one end, and
at least one tensioning device (tensioning device) including a tensioner body between said inner rod and said outer tube for stretching said inner rod in a length direction relative to said outer tube to tension said inner rod, wherein said tensioning device is placed at at least one of an end of a lower probe portion and an end of an upper probe portion of said coaxial probe.

2. The coaxial probe of claim 1, wherein said inner rod has an inner threading and said tensioning device comprises a block having an aperture through which a threaded member is inserted to screw into said an inner threading so that once engaged said threaded member loads said inner rod with a reaction force from said block.

3. The coaxial probe of claim 2, wherein said threaded member comprises a socket head cap screw.

4. The coaxial probe of claim 3, wherein said tensioning device further comprises at least one flexible member positioned between said socket head cap screw and said tensioner body for taking up changes in a dimensions of the coaxial probe due to temperature or a creep over time.

5. The coaxial probe of claim 4, wherein said flexible member comprises a spring or a Bellville washer.

6. The coaxial probe of claim 1, wherein said tensioner body comprises a metal, a chemically resistant polymer, or a ceramic.

7. The coaxial probe of claim 1, wherein said tensioning device provides a tension load to said inner rod of 10 N to 10,000 N.

8. The coaxial probe of claim 1, wherein said coaxial probe is an integral (continuous) probe.

9. The coaxial probe of claim 1, wherein said coaxial probe comprises an upper section a lower section and at least one intermediate section between said upper section and said lower section.

10. A method of tensioning a coaxial probe in a tank connected to an electronic level gauge (ELG) having a lower probe portion and an upper probe portion, comprising:
applying tension to at least one end of an inner electrically conductive rod (inner rod) using at least one tensioning device (tensioning device) between said inner rod and an outer electrically conductive tube (outer tube) including a tensioner body which stretches said inner rod in a length direction relative to said outer tube, and
performing level measurements for a product material in said tank while said inner rod is under said tension.

11. The method of claim 10, wherein said inner rod has an inner threading and said tensioning device comprises a block with an aperture through which a threaded member is inserted to screw into said inner threading so that once engaged said threaded member loads said inner rod with a reaction force from said block.

12. The method of claim 10, wherein said tensioning device provides a tension load to said inner rod of 10 N to 10,000 N.

13. The method of claim 10, wherein said coaxial probe is an integral (continuous) probe.

14. The method of claim 10, wherein said coaxial probe comprises an upper section a lower section and at least one intermediate section between said upper section and said lower section.

15. A guided wave radar (GWR)-based time-domain reflectometry (TDR) level measuring system for mounting onto a tank, comprising:
an electronic level gauge (ELG) including a transceiver, a processor having an associated memory that stores a radar level determination algorithm for determining a level of a product material in said tank as firmware, said ELG coupled to a coaxial probe in said tank;
said coaxial probe comprising:
an outer electrically conductive tube (outer tube);
an inner electrically conductive rod (inner rod) within said outer tube on at least one end, and
at least one tensioning device (tensioning device) including a tensioner body between said inner rod and said outer tube for stretching said inner rod in a length direction relative to said outer tube to tension said inner rod, wherein said tensioning device is placed at at least one of an end of a lower probe portion and an end of an upper probe portion of said coaxial probe.

16. The system of claim 15, wherein said inner rod has an inner threading and said tensioning device comprises a block having an aperture through which a threaded member is inserted to screw into said an inner threading so that once engaged said threaded member loads said inner rod with a reaction force from said block.

17. The system of claim 16, wherein said threaded member comprises a socket head cap screw.

18. The system of claim 17, wherein said tensioning device further comprises at least one flexible member positioned between said socket head cap screw and said tensioner body for taking up changes in a dimensions of the coaxial probe due to temperature or a creep over time.

19. The system of claim 18, wherein said flexible member comprises a spring or a Bellville washer.

20. The system of claim 15, wherein said tensioner body comprises a metal, a chemically resistant polymer, or a ceramic.
